(19) United States
(12) Patent Application Publication
(10) Pub. No.: US 2005/0091178 A1
(43) Pub. Date: Apr. 28, 2005

(54) Inspection state check system

(76) Inventor: Masayuki Inoue, Tokyo (JP)

Correspondence Address: CARRIER BLACKMAN AND ASSOCIATES, 24101 NOVI ROAD, SUITE 100, NOVI, MI, 48375, US

(21) Appl. No.: 10/480,970

(22) PCT Filed: May 29, 2002
(86) PCT No.: PCT/JP02/05175

(30) Foreign Application Priority Data
Jun. 13, 2001 (JP) 2001-179260

(51) Int. Cl. G06F 7/00

(52) U.S. Cl. 707/1

(57) ABSTRACT

A system for verifying a check status includes a display 41, a mobile terminal 30 to which a mechanic inputs a status information indicative of a check status, and a server 10 which makes a display indicate the check status on in real time, in response to the status information sent from the mobile terminal. Accordingly, a user can verify the check status of a vehicle.

### TECHNICAL FIELD

The present invention relates to a system for verifying a check status and more particularly to a technique which reports a status of a check and a maintenance (hereafter, it may be merely referred to, as “check” in this specification) to a user in real time.

### BACKGROUND ART

Conventionally, a check is carried out such that a vehicle, which a user brings into a maintenance shop, is checked and then delivered to the user after the completion of the check. Actually, when the vehicle is brought into the maintenance shop, a reception is firstly carried out by a service adviser. Next, after a current status of the vehicle is verified by a work controller, a diagnosis is carried out. In this diagnosis, after questioning of the condition, symptom reproduction verification and the like are carried out, a reason for a trouble is supposed.

Next, the estimation of a cost and a time required to remove the supposed reason for the trouble is carried out, and presented to the user. Here, if the user admits the presented estimation, a mechanic starts carrying out the check. The user waits for the completion of the check in a waiting room.

In the conventional check as mentioned above, the user only waits for the elapse of the estimated check time in the waiting room. However, there may be a case that the estimated time is postponed, for example, if the presumption of the reason for the trouble is erroneous. Even in such a case, that the user can do is only to wait for. Even if the user asks the service adviser about the check status, since the service adviser himself can not know the check status, he can not explain the check status. Therefore, there is a desire from the user, such as a request to know the current check status.

The present invention is proposed in order to cope with the above-mentioned request. The object of the present invention is to provide a system for verifying a check status, in which a user can verify a check status of a vehicle.

### DISCLOSURE OF INVENTION

In order to attain above object, a system for verifying a check status comprised a display (41), a mobile terminal (30) to which a mechanic enters a status information indicative of a check status, and a processor (10) for indicating the check status on a display (41) in real time, in response to the status information sent from the mobile terminal (30).

According to this system for verifying a check status, a user can verify the check status of a vehicle at any time by viewing the display (41).

This system for verifying a check status may be designed such that the information terminal (30) further comprises a bar code reader (31) for reading a bar code put on a repair card on which a check item is noted, and information read by the bar code reader (31) is sent as status information to the processor (10). According to this design, the user can enter the status information only by scanning the bar code of the repair card with the bar code reader (31). Thus, the status information can be effectively entered even in a work field that is liable to be contaminated.

Also, this system for verifying a check status may be designed such that the processor (10) comprises a transmit unit for sending data indicative of the check status to the information terminal (30), in response to a request from the information terminal (30), and the information terminal (30) comprises a display unit for indicating the data indicative of the check status sent by the transmitter of the processor (10). According to this design, since the check status is indicated on the display unit of the information terminal (30), the check status of the vehicle can be reported to the user at any place.

### BRIEF DESCRIPTION OF DRAWINGS

FIG. 1 is a block diagram showing a configuration of a system for verifying a check status, according to a best mode for carrying out the present invention.

FIG. 2 is a flowchart describing an operation of the system for verifying a check status, according to a best mode for carrying out the present invention.

### BEST MODE FOR CARRYING OUT THE INVENTION

A system for verifying a check status, according to a best mode for carrying out the present invention, will be described below in detail with reference to the drawings.

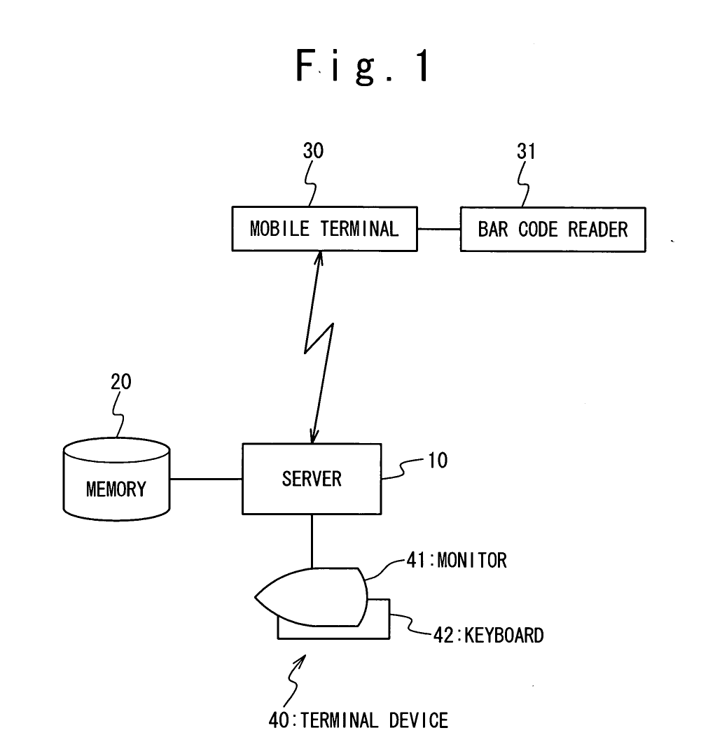

FIG. 1 is a block diagram showing the schematic configuration of the system for verifying a check status, according to the best mode for carrying out the present invention. This system for verifying a check status is composed of a server 10, a memory device 20, a mobile terminal 30 and a terminal device 40. It should be noted that FIG. 1 shows the case in which one mobile terminal 30 is wirelessly connected to the server 10, in order to avoid the drawings from being complex. However, usually, a plurality of mobile terminals is wirelessly connected.

The server 10 corresponds to a processor of the present invention. The server 10 is composed of an information processor, for example, such as a personal computer, a work station and a general-purpose computer. This server 10 controls the memory device 20, the mobile terminal 30 and the terminal device 40, and carries out various operations. The detailed operations executed by this server 10 will be described later.

The memory device 20 is composed of, for example, a disc device. This memory device 20 intensively stores the status information indicative of check statuses, which is sent from a plurality of mobile terminals. The server 10 refers to the status information stored in this memory device 20, if necessary.

The mobile terminal 30 corresponds to an information terminal of the present invention. This mobile terminal 30 is composed of, for example, a palm top computer, and it functions as a repair card in which check items are marked off. This mobile terminal 30 is designed so as to wirelessly communicate with the server 10.

This mobile terminal 30 is composed of a display unit and a keyboard (both of them are not shown). An input of the status information indicative of the check status is carried out by marking off a check item indicated on the display with the keyboard at a time of a start and an end of an operation for a check item. Incidentally, it may be designed such that the mobile terminal 30 is further composed of an input pen, and a touch of a check item through this input pen causes the marking off. Moreover, it may be designed such that the display unit of the mobile terminal is composed of a touch panel, and the touch of a portion in which a check item on this touch panel is indicated causes the marking off.

Also, the mobile terminal 30 sends a transmission request to the server 10, when a register number of a vehicle is inputted by using the keyboard and a predetermined operation is carried out. A message indicative of a check status sent from the server 10 in response to this transmission request is indicated on the display unit. Thus, the message similar to that indicated on a monitor 41 of the terminal device 40 is indicated on the display unit, as described later.

It is designed such that a bar code reader 31 as an option can be connected to this mobile terminal 30. This bar code reader 31 is used to scan a bar code put on the repair card on which the check item is noted, and then inputs the status information indicative of the check status. The usage of this bar code reader 31 enables the status information to be effectively inputted, even in a work section that is liable to be contaminated.

The terminal device 40 is composed of the monitor 41 and a keyboard 42. This terminal device 40 is used to report a check status of a vehicle to a user, and installed in a waiting room for the user who is waiting for the completion of the check.

In this terminal device 40, when the user inputs a register number of his or her vehicle by using the keyboard 42, the check status of the vehicle, for example, the check status such as “Before Maintenance”, “Under Maintenance”, “Wait For Completion Inspection”, “End Of Completion Inspection”, “Under Car Washing” or “Wait For Delivery” is indicated on the monitor 41.

It should be noted that the indication of the check status is not limited to the above mentioned rough indication. It can be designed so as to be an indication at an approximately middle level such as “Under Check Around Engine” or “Under Check Around Leg”. Moreover, it can be designed so as to be an indication in a detailed classification such as the check item itself currently being carried out.

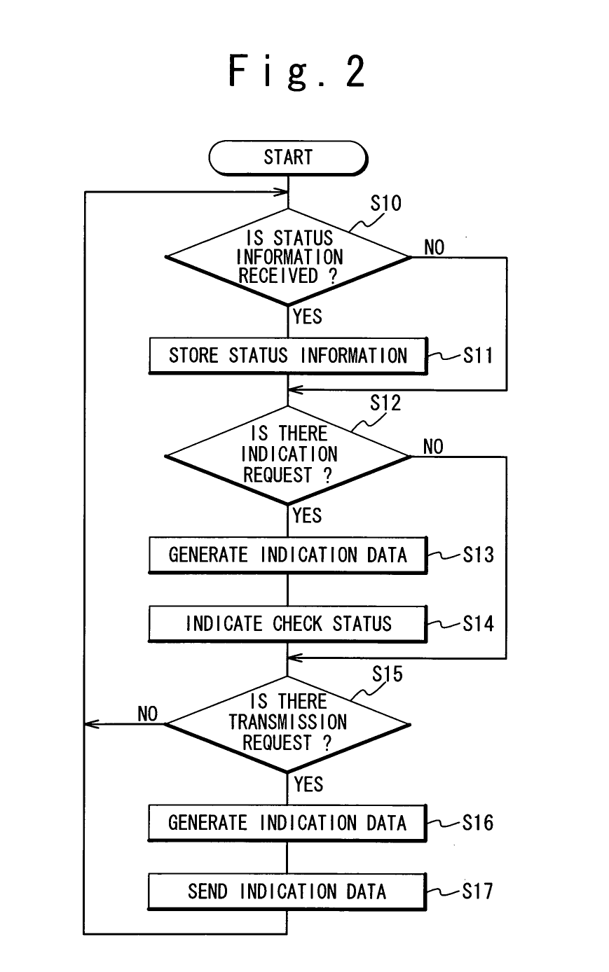

In the above mentioned configuration, the operation of the system for verifying a check status, according to the best mode for carrying out the present invention, will be described below with reference to a flowchart shown in FIG. 2.

In this system for verifying a check status, the server 10 is at the wait state of waiting for an indication request from the terminal device 40 or a reception and transmission request of the status information from the mobile terminal 30. The terminal device 40 sends the indication request to the server 10 when the keyboard 42 is operated. Also, when the status information is inputted, the mobile terminal 30 sends the status information to the server 10, and sends the transmission request to the server 10 when a predetermined operation is carried out by using a keyboard (not shown).

In the wait state, the server 10 firstly judges whether or not the status information is received from the mobile terminal 30 (Step S10). Here, if judging that the status information is received, server 10 stores the status information in the memory device 20. On the other hand, if judging that the status information is not received, the operation at the step S11 is skipped.

Next, it is checked whether or not there is an indication request from the terminal device 40 (Step S12). That is, it is checked whether or not a register number of a vehicle is inputted from the keyboard 42 of the terminal device 40. Here, if it is judged that there is the indication request, an operation for generating an indication data is carried out (Step S13).

In this operation for generating the indication data, the server 10 reads out a status information corresponding to the register number inputted from the keyboard 42, from the memory device 20, and generates indication data to be indicated on the monitor 41 of the terminal device 40, on the basis of this read out status information. For example, if the status information read out from the memory device 20 represents the course of the execution of a check item of “Timing Belt Exchange”, indication data of “Under Maintenance” is generated.

Next, an indication of a check status is carried out (Step S14). That is, the server 10 sends the indication data generated at the step S13 to the monitor 41 of the terminal device 40. Consequently, for example, a message of “Under Maintenance” is indicated on the monitor 41. Thus, a user can verify a current check status of his or her vehicle. At the step S12, if it is judged that there is no indication request from the terminal device 40, the operations at the steps S13 and S14 are skipped.

Next, it is checked whether or not there is a transmission request containing the register number of the vehicle, from the mobile terminal 30 (Step S15). Here, if it is judged that there is the transmission request, indication data is generated (Step S16). This operation for generating the indication data is similar to the operation done at the step S13.

Next, the transmission of the indication data is carried out (Step S17). That is, a transmit unit (not shown) of the server 10 sends the indication data generated at the step S16 to the mobile terminal 30. Consequently, the message having the same content as the monitor 41 as mentioned above is indicated on the display unit of the mobile terminal 30.

Thus, even by viewing not only the terminal device 40 but also this mobile terminal 30, the check status of the vehicle of the user can be known. Hence, for example, if the service adviser carries the mobile terminal 30, the service adviser who is asked about the check status can immediately inform the check status of the vehicle to the user at any place.

After that, the sequence branches into the step S10. Also, even if it is judged that there is no transmission request at the step S15, the sequence branches into the step S10. Then, the operations similar to the above mentioned operations are repeated.

As explained above, in the system for verifying a check status, according to this best mode for carrying out the present invention, the user can verify the check status of his or her vehicle at any time by viewing the monitor. Also, the user can verify the check status of his or her vehicle even by asking the service adviser.

It should be noted that the system for verifying a check status, according to the best mode for carrying out the present invention, is designed so as to report the check status done by the mechanic, through the monitor or the mobile terminal to the user. Moreover, it can be designed so as to report a current position of the vehicle of the user, for example, a maintenance shop, a car wash area, a parking zone or the like, through the monitor or the mobile terminal to the user. In this case, it may be designed such that, for example, a bar code reader is used to input a positional information, for each change in a position of a vehicle. Moreover, if the vehicle of the user is located in the parking zone, it can be designed such that a parking position is indicated on the monitor or the mobile terminal.

Also, since the memory device 20 stores the status information for each check item, the mechanic can calculate a time spent to carry out the check item (a time from a start of a work to an end) on the basis of this status information. If this calculated time is used, it can be used to judge an average operation time with regard to the check items of all mechanics, the skills of the mechanics and the like.

Also, the system for verifying a check status, according to the best mode for carrying out the present invention, uses the mobile terminal wirelessly connected to the server, as the information terminal. However, the system for verifying a check status of the present invention can use a terminal connected to the server in a wired manner, as the information terminal.

Moreover, the system for verifying a check status, according to the best mode for carrying the present invention, is designed such that when the vehicle is checked in a short time while the user is at the wait state in the waiting room, the user can know the check status from the monitor in the waiting room. However, there may be a case that it takes several days to check and maintain the vehicle. In order to cope with such a case, the terminal device 40 can be configured so as to send the information indicative of the check status to a personal computer or a portable telephone of the user. In this case, it can be designed such that the user sends the register number of his or her vehicle from his or her personal computer or portable telephone, to the terminal device 40, and the terminal device 40 responds to it and returns the information indicative of the check status of the vehicle. This design can improve the service to the user.

### Industrial Applicability

As detailed above, the system for verifying a check status, according to the present invention, enables the user to verify the check status of the vehicle.

1. A system for verifying a check status, comprising:
a display;
an information terminal to which a mechanic inputs a status information indicative of a check status; and
a processor which makes said display indicate said check status thereon in real time, in response to said status information sent from said information terminal.

2. The system for verifying a check status, according to claim 1, wherein said information terminal comprises a bar code reader which reads a bar code put on a repair card on which a check item is noted, and
information read by said bar code reader is sent as said status information to said processor.

3. The system for verifying a check status, according to claim 1, wherein said processor comprises a transmit unit which sends data indicative of said check status to said information terminal, in response to a request from said information terminal, and
said information terminal comprises a display unit which indicates said data indicative of said check status sent by said transmit unit of said processor.

4. The system for verifying a check status, according to claim 1, wherein said information terminal further comprises a check status obtaining unit which obtains said status information of an apparatus that is being checked by said mechanic, and
wherein said check status obtaining unit sends said status information to said processor.

5. The system for verifying a check status, according to claim 1, wherein said display is included in a terminal device,
said terminal device further includes a input unit to which a user of an apparatus that is being checked by said mechanic inputs a indication request information, and
said processor transmits said check status to said terminal device such that said display indicates said check status, in response to said indication request information sent from said terminal device.

6. The system for verifying a check status, according to claim 5, further comprising:
a memory device which stores said check status and an ID number of said apparatus, wherein said check status is related to said ID number,
wherein said processor transmits said check status to said terminal device, in response to said indication request information which includes said ID number sent from said terminal device.

7. The system for verifying a check status, according to claim 6, wherein said apparatus includes a vehicle.

8. The system for verifying a check status, according to claim 7, wherein said terminal device is installed in a waiting room for said user who is waiting for completion of said check by said mechanic.

9. The system for verifying a check status, according to claims 8, wherein said check status includes check items.

10. A method of verifying a check status, comprising:
receiving a status information indicative of a check status of an apparatus that is being checked by a mechanic; and
indicating said check status on a display in real time, in response to said status information,
wherein said display is installed in a place where at least one of a user of said apparatus and said mechanic are in.

11. The method of verifying a check status, according to claim 10, further comprising the steps of:
storing said status information in a memory device;
receiving an indication request information including an ID number of said apparatus, wherein said indication request information shows a request for indicating said status information on said display;
obtaining said status information from said memory device, based on said indication request information; and
indicating said check status on said display, in response to said indication request information.

12. The method of verifying a check status, according to claim 11, wherein said display is installed in a waiting room for said user who is waiting for completion of said check by said mechanic.

13. The method of verifying a check status, according to claim 12, wherein said apparatus includes a vehicle.

14. The method of verifying a check status, according to claims 13, wherein said check status includes check items.

15. The system for verifying a check status, according to claim 1, wherein said information terminal is a mobile information terminal.

16. The system for verifying a check status, according to claim 1, wherein said terminal device is installed in a waiting room for said user who is waiting for completion of said check by said mechanic.

17. The method of verifying a check status, according to claim 10, wherein the mechanic inputs said status information via a mobile information terminal.

18. The method of verifying a check status, according to claim 17, wherein said mobile information terminal comprises a bar code reader which reads a bar code placed on a repair card on which a check item is noted, and said status information is read by said bar code reader.
